(19) United States
(12) Patent Application Publication
(10) Pub. No.: US 2005/0171875 A1
(43) Pub. Date: Aug. 4, 2005

(54) System and method for synchronizing commitment updates

(76) Inventor: Michael Seitz, Speyer (DE)

Correspondence Address: KENYON & KENYON, 1 BROADWAY, NEW YORK, NY, 10004, US

(21) Appl. No.: 10/834,230

(22) Filed: Apr. 29, 2004

Related U.S. Application Data
(60) Provisional application No. 60/540,013, filed on Jan. 30, 2004.

(51) Int. Cl. G06F 17/60

(52) U.S. Cl. 705/30; 705/35

(57) ABSTRACT

A method and system for maintaining consistency of financial commitment information across a plurality of financial systems. According to one embodiment, a contract accounting system receives from a billing system a commitment update posting a liability of a business partner, the liability having been and remaining posted to a credit management system by the billing system, the credit management system maintaining current liability information associated with the business partner, calculates an updated liability of the business partner based at least in part upon the liability posted by the billing system, and sends to the credit management system a commitment update clearing the liability posted by the billing system and posting the calculated updated liability.

### CROSS REFERENCE TO RELATED APPLICATIONS

This application claims the benefit under 35 U.S.C. § 119(e) of U.S. Provisional Application No. 60/540,013, filed Jan. 30, 2004, which is hereby incorporated by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND OF THE INVENTION

In a typical organization with a very high volume of business partners (i.e., customers), there usually is at least a billing system, a contract accounting system, a customer relationship management (“CRM”) system and a credit management system.

The billing system calculates and prints out invoices for the services offered to the customer. In a telecommunications company, for example, such services could be Internet, mobile, wired national calls, wired international calls, etc.

The contract accounting system manages the open items resulting from the invoices created in the billing system and further charges created for the payment and dunning process (e.g., dunning charges, interest, etc.).

The CRM system enables a company to better serve its customers through the introduction of reliable service automated processes, personal information gathering and processing, and self-service. It attempts to integrate and automate the various customer-serving processes within a company. For example, when a customer calls the customer service center of a telecommunications company (e.g., to sign a contract for a mobile phone plan), the customer generally talks to a user of a CRM system.

And the credit management system manages the commitments (i.e., liabilities) and credit limits of the business partners. A commitment of a business partner is the value (usually in money) that the business partner has to pay, including all open receivables, non-invoiced orders (e.g., rated but unbilled phone calls) and so on. Thus, the credit management system provides a complete view over all existing commitments of a business partner, such as all outstanding open items (from the contract accounting system), contracts (from the CRM system), created bills (from the billing system), etc.

In addition, the credit management system can calculate an internal credit worthiness based on credit relevant data stored in the system for each business partner like ratings from external agencies, payment behavior in the past, etc. With this internal credit worthiness a business partner specific credit limit can be calculated on which credit decisions may be based. For example, whenever an organization wishes to create a new order for a business partner, the credit management system may be contacted to check whether the business partner has exceeded his/her credit limit. If so, the creation of a new order can be prevented by the system.

In order for a credit management system to manage the commitments and credit limits of a business partner, other systems that manage commitment information for the business partner (e.g., billing systems, contract accounting systems, etc.) must report this information to the credit management system to keep it up to date. Generally it is a problem to keep the commitment information synchronous when it is passed from one system to another, since commitments have to be cleared in the sending systems and posted in the receiving system. Such a problem can lead to incorrect credit decisions.

Illustrating this problem by way of an example, assume a customer owes a company $125 on a previous invoice ($120+$5 dunning charge) and incurs a $100 liability with the company. The company's billing system creates an invoice for the $100 liability and posts this amount to the company's credit management system to increase the customer's total liability by $100. The company's contract accounting system already includes the previous $120 invoice and $5 dunning charge, and has already posted the $125 liability to the credit management system. Thus, the total liability for the customer in the credit management system is $225 ($100+$120+$5).

In order to receive the money from the customer, the billing system then transfers the invoice to the contract accounting system and reduces the liability in the credit management system by $100. Thus, the total customer liability in the credit management system is $125 ($225-$100) until the invoice is posted in the contract accounting system, which posts the $100 liability back to the credit management system.

In the time period between the billing system clearing the $100 liability from the credit management system and the contract accounting system posting the $100 liability back to the credit management system, the customer's total liability as reflected in the credit management system is $100 below the correct amount, potentially leading to an incorrect credit decision. For instance, assuming the customer's credit limit is $230, during this time period the customer could buy a new $75 mobile phone because a credit check to the credit management system revealed the customer's total liability to be only $125, leading to the following incorrect credit decision:

| | | |
|---|---|---|
| Credit Limit: | 230 | |
| Total of liability: | 125 | |
| New Liability: | + 75 | |
| | 200 | => credit limit not exceeded |

when the correct credit decision should have revealed the customer's total liability to be $225:

| | | |
|---|---|---|
| Credit Limit: | 230 | |
| Total of liability: | 225 | |
| New Liability: | + 75 | |
| | 300 | => credit limit exceeded |

Due to the high volume of business partners (e.g., in the millions), it is possible that, due to inherent computing limitations, not all commitments of the business partners can be reported from a contract accounting system to a credit management system quickly (e.g., on a daily basis). This results in a longer time period as described above within which the total liability amount for a business partner could be inaccurate, leading to a greater possibility of an incorrect credit decision being made.

Accordingly, there is a need in the art for a system and method that reduces the possibility of incorrect credit decisions based on inaccurate commitment information in a complex financial system environment.

### SUMMARY OF THE INVENTION

Embodiments of the present invention provide for maintaining consistency of financial commitment information across a plurality of financial systems. According to one embodiment, a contract accounting system receives from a billing system a commitment update posting a liability of a business partner, the liability having been and remaining posted to a credit management system by the billing system, the credit management system maintaining current liability information associated with the business partner, calculates an updated liability of the business partner based at least in part upon the liability posted by the billing system, and sends to the credit management system a commitment update clearing the liability posted by the billing system and posting the calculated updated liability.

Because the liability transferred from the billing system to the contract accounting system is not cleared in the credit management system before the transfer, the present invention ensures that the current liability information associated with the business partner in the credit management system is maintained in a consistent state at all times.

### BRIEF DESCRIPTION OF THE DRAWINGS

FIG. 1 is a flow chart that depicts a process for synchronizing commitment updates in accordance with an embodiment of the present invention.

FIG. 2 is a block diagram that depicts the data flow and structure of synchronizing commitment updates in accordance with an embodiment of the present invention.

FIG. 3 is a block diagram that depicts a user computing device in accordance with an embodiment of the present invention.

FIG. 4 is a block diagram that depicts a system architecture for synchronizing commitment updates in accordance with an embodiment of the present invention.

FIG. 5 is a sequence diagram that depicts a commitment update synchronization scenario in accordance with an embodiment of the present invention.

FIG. 6 is a sequence diagram that depicts an apportioned liability determination scenario in accordance with an embodiment of the present invention.

FIG. 7 is a screen shot that depicts an account display screen in accordance with an embodiment of the present invention.

FIG. 8 is a screen shot that depicts a credit data transfer screen in accordance with an embodiment of the present invention.

FIG. 9 is a screen shot that depicts a business partner display screen in accordance with an embodiment of the present invention.

### DETAILED DESCRIPTION COMMITMENT UPDATE SYNCHRONIZATION

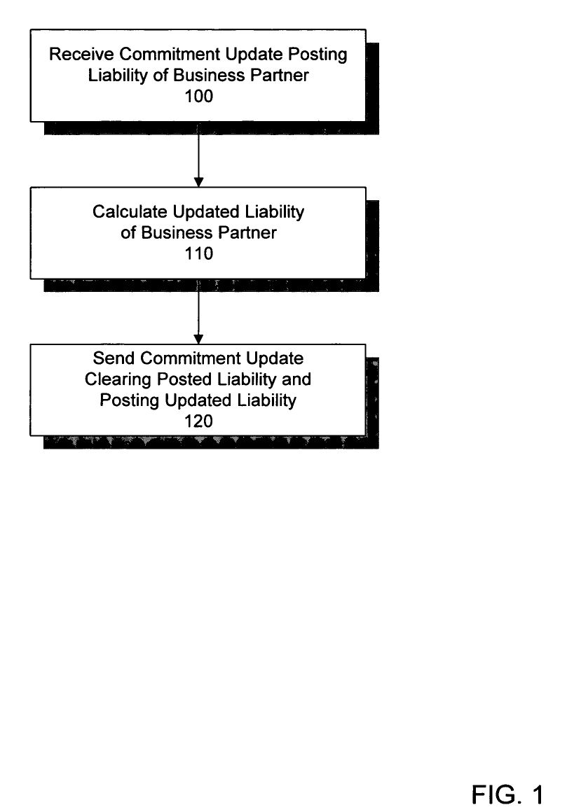

FIG. 1 depicts a process for commitment update synchronization in accordance with an embodiment of the present invention. A third financial system receives from a first financial system a commitment update posting a liability of a business partner, the liability having been and remaining posted to a second financial system by the first financial system, the second financial system maintaining current liability information associated with the business partner (step 100), calculates an updated liability of the business partner based at least in part upon the liability posted by the first financial system (step 110), and sends to the second financial system a commitment update clearing the liability posted by the first financial system and posting the calculated updated liability (step 130).

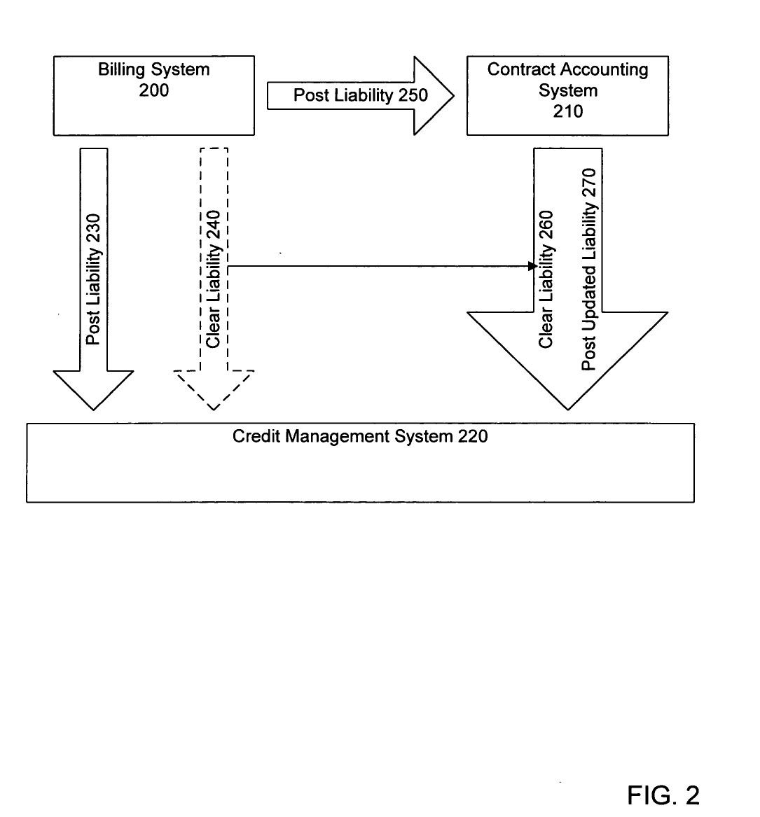

FIG. 2 portrays how the process illustrated in FIG. 1 may be applied to an organization comprising a billing system (200), a contract accounting system (210) and a credit management system (220). As shown in FIG. 2, when billing system 200 creates an invoice for a business partner, it posts the liability to credit management system 220 so that the business partner's total commitments may be updated (step 230). However, when it is time to transfer the invoice to contract accounting system 210 (step 250), billing system 200 does not clear the liability posted in credit management system 220 (step 240), but rather allows the liability to be cleared by contract accounting system 210 (step 260) at the same time it posts an updated liability based at least in part upon the received liability (step 270). In this manner, no time period exists due to the transfer of the invoice within which the total liability amount for the business partner could be inaccurate in credit management system 220.

### Architecture

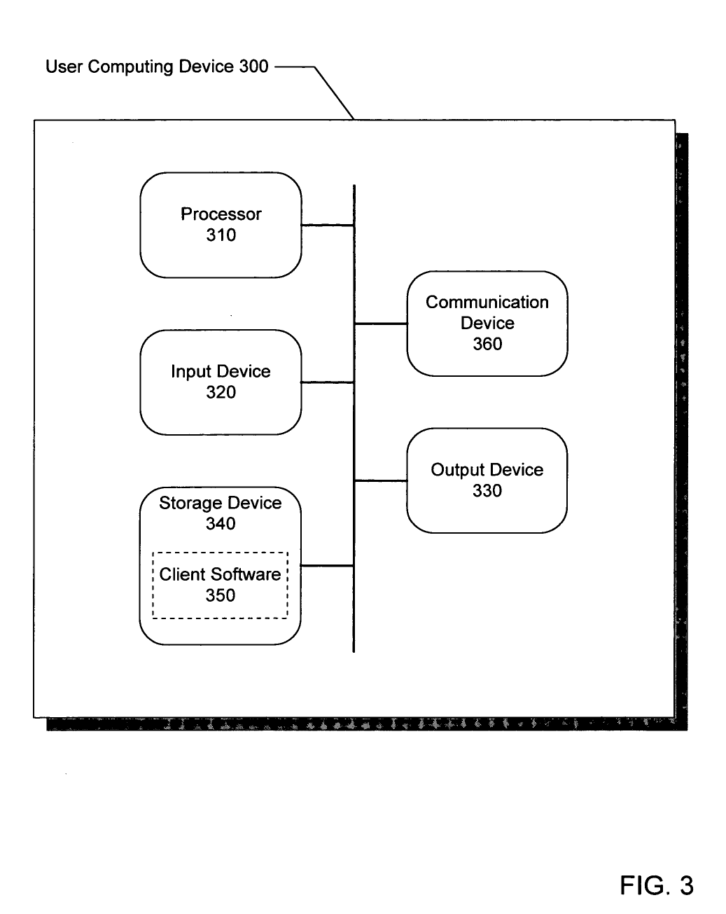

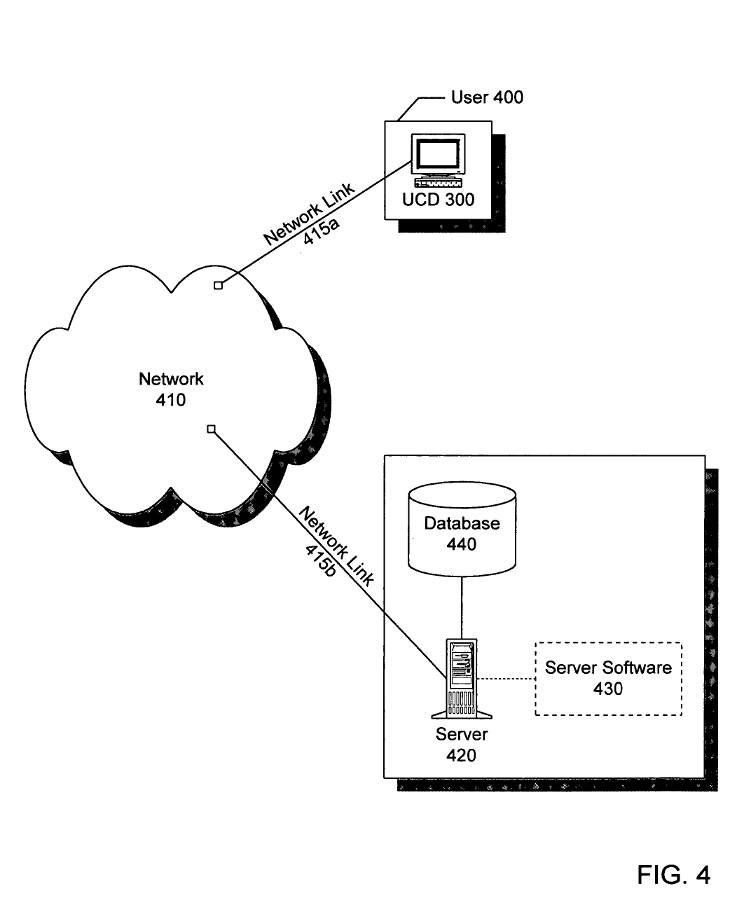

FIGS. 3 and 4 illustrate the components of a basic computer and network architecture in accordance with an embodiment of the present invention. FIG. 3 depicts user computing device 300, which may be a personal computer, workstation, handheld personal digital assistant (“PDA”), or any other type of microprocessor-based device. User computing device 300 may include a processor 310, input device 320, output device 330, storage device 340, client software 350, and communication device 360.

Input device 320 may include a keyboard, mouse, pen-operated touch screen or monitor, voice-recognition device, or any other device that accepts input. Output device 330 may include a monitor, printer, disk drive, speakers, or any other device that provides output.

Storage device 340 may include volatile and nonvolatile data storage, including one or more electrical, magnetic or optical memories such as a RAM, cache, hard drive, CD-ROM drive, tape drive or removable storage disk. Communication device 360 may include a modem, network interface card, or any other device capable of transmitting and receiving signals over a network. The components of user computing device 300 may be connected via an electrical bus or wirelessly.

Client software 350 may be stored in storage device 340 and executed by processor 310, and may include, for example, the client side of a client/server application such as a billing system, the contract accounting component FI-CA by SAP AG or the credit management component by SAP AG that embody the functionality of the present invention.

FIG. 4 illustrates a network architecture in accordance with an embodiment of the present invention. According to one particular embodiment, when user 400 of an organization accesses a billing, contract accounting or credit management application, client software 350 of user computing device 300 communicates with server software 430 (e.g., the server side of a billing system, the contract accounting component FI-CA by SAP AG or the credit management component by SAP AG) of server 420 via network links 415 and network 410.

Network links 415 may include telephone lines, DSL, cable networks, T1 or T3 lines, wireless network connections, or any other arrangement that implements the transmission and reception of network signals. Network 410 may include any type of interconnected communication system, and may implement any communications protocol, which may secured by any security protocol.

Server 420 includes a processor and memory for executing program instructions as well as a network interface, and may include a collection of servers. In one particular embodiment, server 420 may include a combination of enterprise servers such as an application server and a database server. Database 440 may represent a relational or object database, and may be accessed via a database server.

User computing device 300 and server 420 may implement any operating system, such as Windows or UNIX. Client software 350 and server software 430 may be written in any programming language, such as ABAP, C, C++, Java or Visual Basic.

### EXAMPLE FLOW AND USER INTERFACE

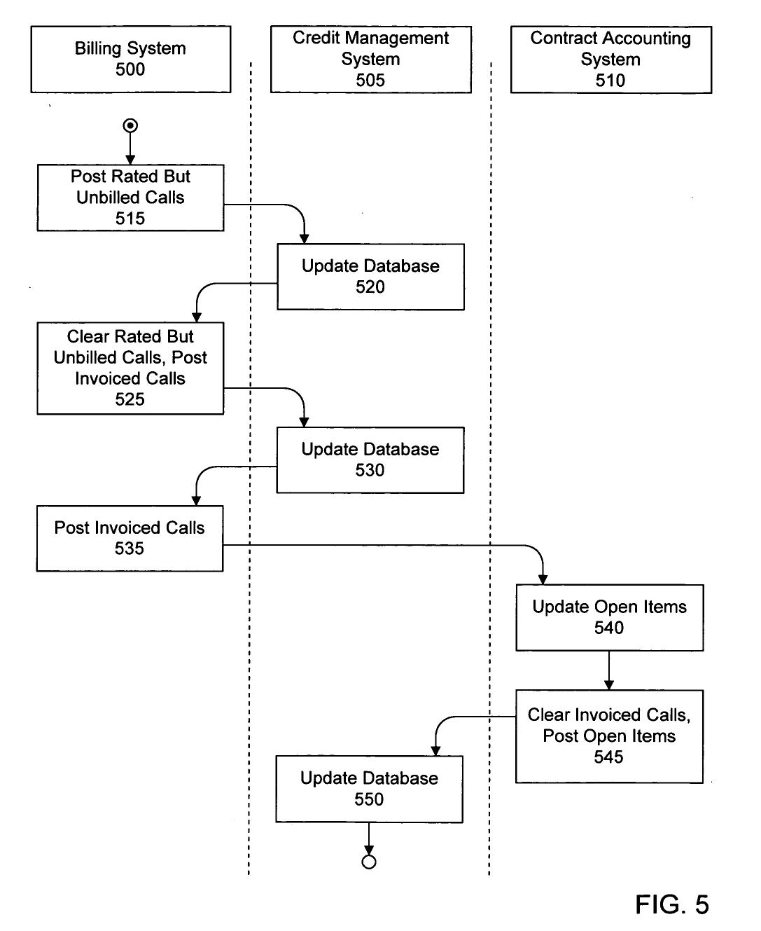

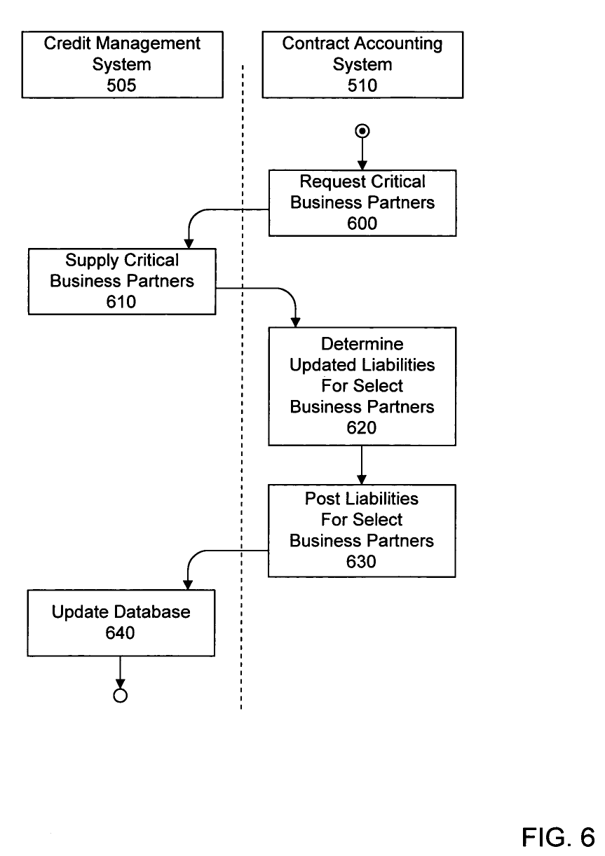

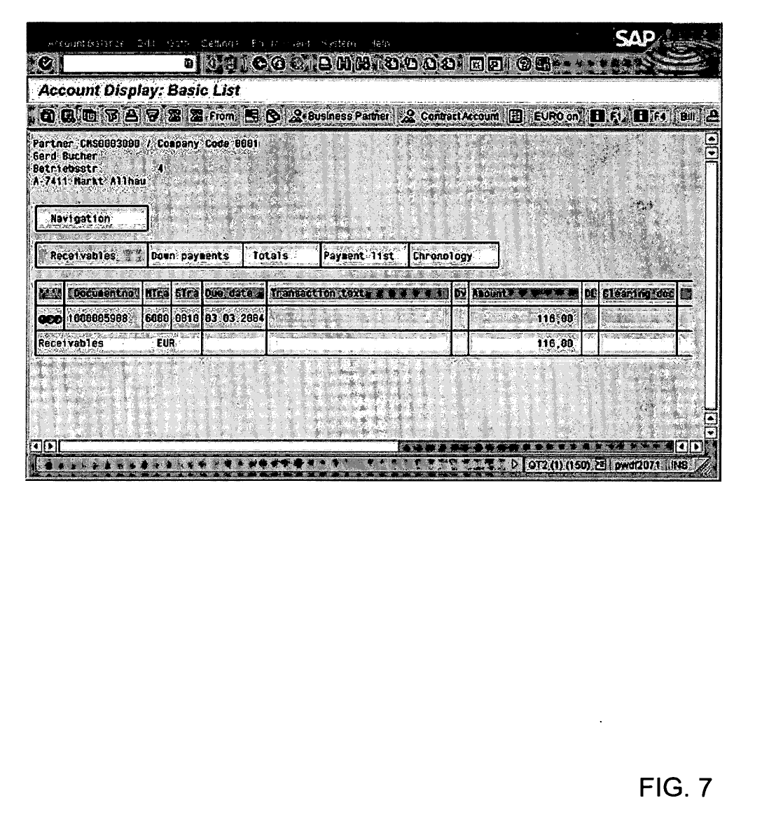

In accordance with an embodiment of the present invention, FIG. 5 depicts a commitment update synchronization scenario and FIG. 6 depicts an apportioned liability determination scenario in the telecommunications area. FIGS. 7-9 illustrate representative user interface screens for the apportioned liability determination scenario.

In FIG. 5, billing system 500 posts $150 of rated but unbilled calls of a business partner to credit management system 505 (step 515), which then updates the commitment information for the business partner in its database (step 520) as follows:

TABLE 1

| rated but unbilled | invoiced | open items |
|---|---|---|
| 150 | — | — |

As shown in TABLE 1, credit management system 505 may hold different types of commitments for business partners, such as liabilities for rated but unbilled calls, invoices, and open items.

When billing system 500 creates an invoice for the $150, it clears the rated but unbilled calls commitment in credit management system 505, replacing it with an invoice commitment (step 525). Credit management system 505 updates the commitment information for the business partner in its database (step 530) as follows:

TABLE 2

| rated but unbilled | invoiced | open items |
|---|---|---|
| 0 | 150 | — |

After the $150 is invoiced, billing system 500 then transfers the invoice to contract accounting system 510 (step 535). Upon receiving the invoice, contract accounting system 510 calculates an updated liability of the business partner (step 540), which includes the $150 invoice and a $5 dunning charge. Contract accounting system 510 then proceeds to clear the invoice commitment in and at the same time replace it with the calculated updated liability (step 545). Credit management system 505 updates the commitment information for the business partner in its database (step 550) as follows:

TABLE 3

| rated but unbilled | invoiced | open items |
|---|---|---|
| — | 0 | 155 |

The commitments posted to credit management system 505 by billing system 500 that remain posted until cleared by contract accounting system 510 may be associated with an identifier to enable contract accounting system 510 to recognize that a particular commitment received from another system has not yet been cleared in credit management system 505, and to enable credit management system 505 to quickly locate the appropriate commitment for clearing in step 550. The identifier may be, for example, the same as the corresponding invoice number or a concatenated string of the invoice number and the system ID of the billing system.

FIG. 6 depicts a process by which contract accounting system 510 may intelligently update the commitments of a high volume of business partners and transfer them to credit management system 505.

In step 600, contract accounting system 510 requests a list of the critical business partner from credit management system 505. In step 610, credit management system 505 supplies the list of critical partners to contract accounting system 510. In step 620, upon receiving this list, contract accounting system 510 determines updated liabilities only for select business partners, which may include the listed critical business partners and a percentage of the least recently updated business partners (the percentage being specified by a user through a graphical user interface). In step 630, contract accounting system 510 posts the liabilities for the select business partners to credit management system 505, at which time credit management system 505 updates the commitment information in its database in step 640.

According to one embodiment of the present invention, FIG. 7 shows an account display screen of contract accounting system 510. This screen displays a document with one open item of 116 EURO that is posted on the contract account of business partner CMS0003000.

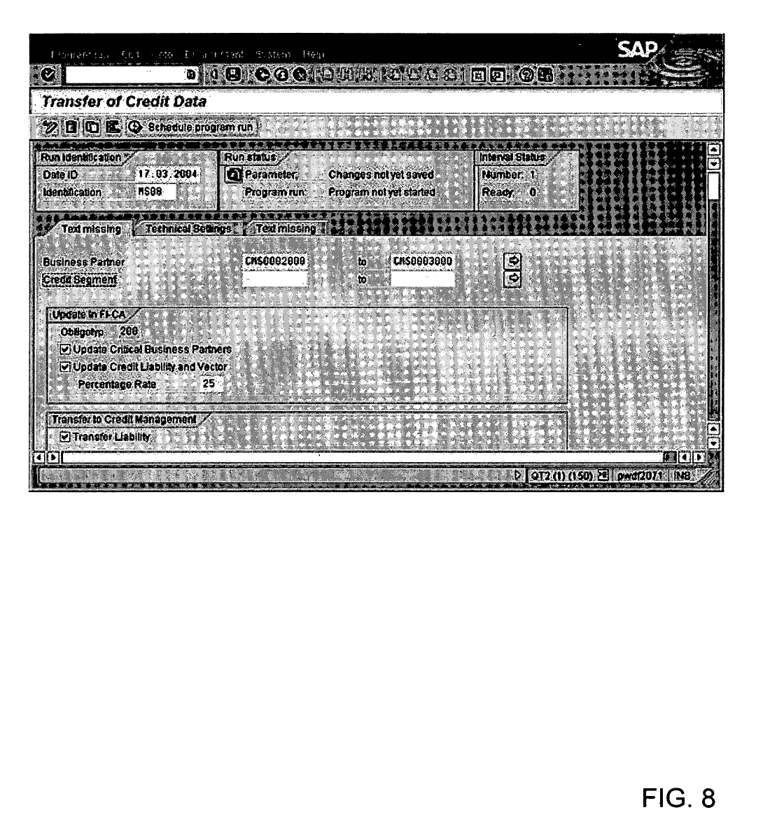

FIG. 8 shows a credit data transfer screen through which a user of contract accounting system 510 has checked the flag “Update Critical Business Partners” and has selected a range of business partners from CMS0002000 to CMS0003000. If business partner CMS0003000 is determined to be a critical business partner by credit management system 505 in step 610, then the liabilities of business partner CMS0003000 will be updated during the next program run. The rule specifying whether a business partner is “critical” may be defined in credit management system 505. It is for example possible that a business partner automatically becomes critical whenever the credit exposure is over 100%; the critical flag may also be set manually.

By checking the flag “Update Credit Liability and Vector” and inserting a percentage rate of 25, the user specifies the liabilities of 25% of the least recently updated business partners to be updated during the next program run. The date and time of the last liability update is a field in the liabilities table to implement this functionality.

By checking the flag “Transfer Liability”, the user specifies that the updated liabilities be transferred to credit management system 505 after the next program run. After the transfer of the liability, the total liability in credit management system 505 is updated, so that if a credit decision is triggered, for example by creation of an order in CRM, the latest liability in credit management system 505 can be checked against the up-to-date credit limit.

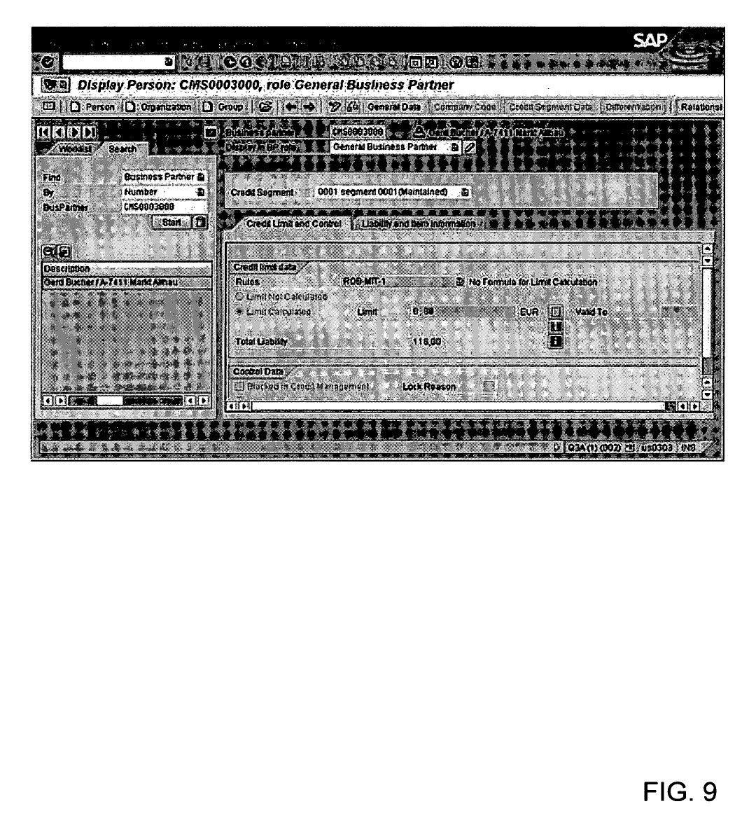

FIG. 9 shows a business partner display screen in credit management system 505, showing the updated 116 EURO “Total Liability” of business partner CMS0003000.

Several embodiments of the invention are specifically illustrated and/or described herein. However, it will be appreciated that modifications and variations of the invention are covered by the above teachings and within the purview of the appended claims without departing from the spirit and intended scope of the invention.

1. A computer-implemented method for maintaining consistency of financial commitment information across a plurality of financial systems, comprising:
receiving from a first financial system a commitment update posting a liability of a business partner, the liability having been and remaining posted to a second financial system by the first financial system, the second financial system maintaining current liability information associated with the business partner;
calculating by a third financial system an updated liability of the business partner based at least in part upon the liability posted by the first financial system; and
sending to the second financial system a commitment update clearing the liability posted by the first financial system and posting the updated liability calculated by the third financial system.

2. The method of claim 1, wherein the first financial system is a billing system.

3. The method of claim 2, wherein the liability posted by the first financial system includes an invoiced amount owed by the business partner.

4. The method of claim 3, wherein the business partner is a customer of a telecommunications company.

5. The method of claim 4, wherein the liability posted by the first financial system includes an amount owed by the business partner for rated but unbilled telephone calls.

6. The method of claim 1, wherein the second financial system is a credit management system for managing liabilities of business partners.

7. The method of claim 1, wherein the third financial system is a contract accounting system for managing the payment and dunning process associated with liabilities associated with business partners.

8. The method of claim 7, wherein the updated liability calculated by the third financial system includes at least one of a dunning charge and an interest charge owed by the business partner.

9. The method of claim 1, wherein an identifier is associated with the liability posted by the first financial system to the second financial system and third financial system.

10. An apparatus for maintaining consistency of financial commitment information across a plurality of financial systems, comprising:
a processor; and
a memory storing instructions adapted to be executed by said processor to:
receive from a first financial system a commitment update posting a liability of a business partner, the liability having been and remaining posted to a second financial system by the first financial system, the second financial system maintaining current liability information associated with the business partner,
calculate by a third financial system an updated liability of the business partner based at least in part upon the liability posted by the first financial system, and
send to the second financial system a commitment update clearing the liability posted by the first financial system and posting the updated liability calculated by the third financial system.

11. The apparatus of claim 10, wherein the liability posted by the first financial system includes an invoiced amount owed by the business partner.

12. The apparatus of claim 10, wherein the updated liability calculated by the third financial system includes at least one of a dunning charge and an interest charge owed by the business partner.

13. A system for maintaining consistency of financial commitment information across a plurality of financial systems, comprising:
means for receiving from a first financial system a commitment update posting a liability of a business partner, the liability having been and remaining posted to a second financial system by the first financial system, the second financial system maintaining current liability information associated with the business partner;
means for calculating by a third financial system an updated liability of the business partner based at least in part upon the liability posted by the first financial system; and
means for sending to the second financial system a commitment update clearing the liability posted by the first financial system and posting the updated liability calculated by the third financial system.
